(19) United States
(12) Patent Application Publication
(10) Pub. No.: US 2005/0138205 A1
(43) Pub. Date: Jun. 23, 2005

(54) Bar Coded Addressing Technique

(75) Inventor: Ronald H. Naismith, North Andover, MA (US)

Correspondence Address: SQUARE D COMPANY;INTELLECTUAL PROPERTY DEPARTMENT, 1415 SOUTH ROSELLE ROAD, PALATINE, IL, 60067, US

(73) Assignee: SCHNEIDER AUTOMATION SAS, Sophia Antipolis (FR)

(21) Appl. No.: 10/707,482

(22) Filed: Dec. 17, 2003

(51) Int. Cl. G06F 15/16; G06K 7/10

(52) U.S. Cl. 709/245; 709/250; 235/462.01

(57) ABSTRACT

A method and apparatus for identifying MAC addresses using bar codes is explained. A label that includes the MAC address in bar code format is attached to a network device and used with a bar code reader to enter the MAC address into system network tables.

### BACKGROUND OF INVENTION

1. Technical Field

The present invention pertains to the field of computer networking, particularly in the area of industrial automation and control as related to addressing of devices on the network.

2. Background

As computer networks have become more sophisticated and flexible, a number of usability issues have arisen that make certain aspects of network design and maintenance more complex. In the effort to provide transparency of locations and flexibility of routing of messages across wide domains, several layers of abstraction have been incorporated in the network protocol architecture to hide the true address of a device. In most cases this make the user's situation easier, for once the user has a set of hardware, a network administrator sets up the abstractions and the user is free to use his device without concern.

For example, a user with a personal computer may have an Ethernet chip that contains a set MAC (also know as IEEE Global Address) address that is the true physical address of his personal computer. A network administrator will assign this MAC address an IP address (an IP address is an Internet Protocol address used by network devices to determine where to send network messages) either directly or from a pool of IP addresses through either a BOOTP or DHCP server. This server is a simple database that translates the virtual IP address into the actual MAC address. In addition, there is a further level of abstraction with a URL that maps a name to an IP address that is further mapped to a MAC address.

This works fairly well in an office environment where there are few changes to the equipment over the course of time and where the impact of a few hours delay waiting for a network administrator to update tables should a failure occur is small. However, in a factory environment, failures are more prevalent. Wide changes in voltage can damage electronic components, forklifts can collide with factory computers, and dust and dirt can cause frequent failure of computer and networking equipment. And in a factory environment, the cost of downtime can be quite large. Failure of certain factory equipment can mean that the factory, or a portion of it, is not producing product. This can lead to loss of income to the factory. Furthermore, many factories operate 24 hours a day, seven days per week. Operation of the factory during off shifts are typically handled by operators. There are usually no network administrators to update the DHCP or BOOTP tables should a component need to be replaced.

Factories are automated using a number of devices, many of which are computerized. The more complex computerized factory automation devices often will include network access, either through an integrated network chip or through an add-in board. These factory automation devices may include programmable logic controllers, human machine interfaces, message boards, push button panels, factory personal computers, intelligent input and/or output devices, motor starters, power monitoring and management devices, intelligent relays, sensors and many other automation devices.

Traditionally, factory networks solved this problem by using simple protocols that were based upon switches or dials that specified the network address of a device. However, with the use of Ethernet and other complex network architectures as the factory network, dials were not longer practical. Instead, standard network addressing schemes using MAC addressing and DHCP or BOOTP servers have replaced the dials.

As a result, operators are required to change failed equipment in the shortest possible amount of time, and on shifts where little assistance is available. It is important, therefore, to design the ergonomics of the factory network to allow for simple replacement of network components. The present invention solves this and other problems.

### SUMMARY OF INVENTION

The present invention is directed to a network device for an industrial control that consists of a network connection between the network device and an industrial control network where the MAC address of the network device provides an unique address on the industrial control network and a representation of the MAC address in a bar code format visible on said network device.

Another aspect of the present invention is directed to a network device for an industrial control that consists of a network connection between the network device and an industrial control network where the MAC address of the network device provides an unique address on the industrial control network and a representation of the MAC address in a bar code format visible on said network device. Here, the bar code is read by a bar code reader that communicates the MAC address to a DHCP or a BOOTP server.

A further aspect of the present invention is directed to a network device for an industrial control that consists of a network connection between the network device and an industrial control network where the MAC address of the network device provides an unique address on the industrial control network and a representation of the MAC address in a bar code format visible on said network device. Furthermore, the network device is a programmable logic controller.

An object of the present invention is directed to a network device for an industrial control that consists of a network connection between the network device and an industrial control Ethernet network where the MAC address of the network device provides an unique address on the industrial control network and a representation of the MAC address in a bar code format visible on said network device.

Another aspect of the present invention is the method of assigning a network address to a MAC address on an industrial control network using the steps of indicating the desire to replace a first network device with a second network device, then scanning the bar code that contains the MAC address of the first device, then scanning the bar code that contains the MAC address of the second device, and then updating a network database, replacing the first MAC address with the second MAC address.

A further aspect of the present invention is the method of assigning a network address to a MAC address on an industrial control network using the steps of indicating the desire to replace a first network device with a second network device, then scanning the bar code that contains the MAC address of the first device, then scanning the bar code that contains the MAC address of the second device, and then updating a BOOTP or DHCP database, replacing the first MAC address with the second MAC address.

Another aspect of the present invention is the method of assigning a network IP address to a MAC address on an industrial control network using the steps of indicating the desire to replace a first network device with a second network device, then scanning the bar code that contains the MAC address of the first device, then scanning the bar code that contains the MAC address of the second device, and then updating a network database, replacing the first MAC address with the second MAC address.

Another aspect of the present invention is the method of assigning a network address to a MAC address on an industrial control network using the steps of indicating the desire to replace a first network device with a second network device, then scanning the bar code that contains the MAC address of the first device, then scanning the bar code that contains the MAC address of the second device, and then updating a network database, replacing the first MAC address with the second MAC address. This method further includes the step of physically replacing the first device with the second device.

A further aspect of the present invention is the method of assigning a network address to a MAC address on an industrial control network by indicating the desire to add a network device to a network database, then scanning a bar code that contains a MAC address of the network device, then identifying an Internet Protocol (IP) address, and finally updating a network database, adding the MAC address and the IP address to the network database.

A further aspect of the present invention is the method of assigning a network address to a MAC address on an industrial control network by indicating the desire to add a network device to a network database, then scanning a bar code that contains a MAC address of the network device, then reading the bar code of an Internet Protocol (IP) address, and finally updating a network database, adding the MAC address and the IP address to the network database.

A further aspect of the present invention is the method of assigning a network address to a MAC address on an industrial control network by indicating the desire to add a network device to a DHCP or BOOTP database, then scanning a bar code that contains a MAC address of the network device, then identifying an Internet Protocol (IP) address, and finally updating a DHCP or BOOTP database, adding the MAC address and the IP address to the network database.

### BRIEF DESCRIPTION OF DRAWINGS

FIG. 1 is a drawing of a network device.

FIG. 2 is a diagram of a factory automation network.

FIG. 3 is a flow chart of the procedure to enter a new device into a DHCP server using a bar code.

FIG. 4 is a flow chart of the procedure to replace a device with a new device.

### DETAILED DESCRIPTION

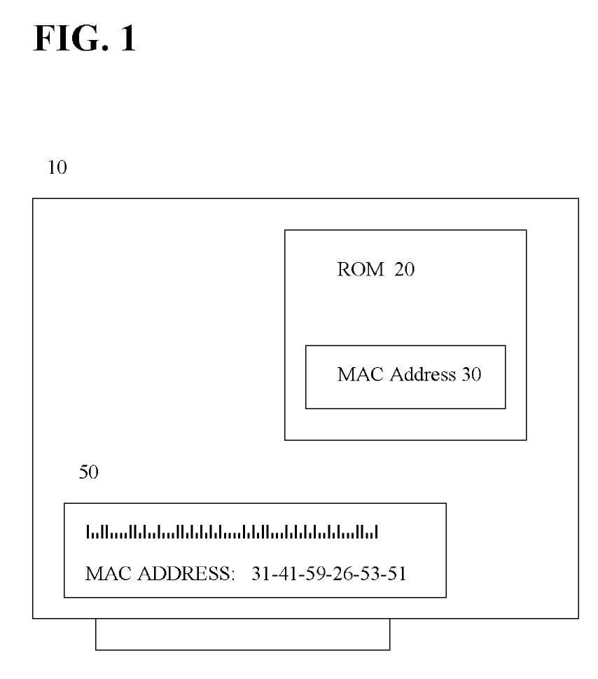

When any Ethernet device 10 is manufactured, an unique address 30 is programmed into the non-volatile memory 20 of the device 10. This unique address 30 is called a MAC address. It is also know as an IEEE Global Address. This address is assigned by a standards body in blocks to individual manufacturers, who place the address in a permanent memory location within the device. This relationship is seen in FIG. 1. However, a user must know the value of this MAC address 30, so a label is placed on the product that contains the address 50 in some form. The address label 50 in FIG. 1 is in bar code format and may also include the number in ASCII format.

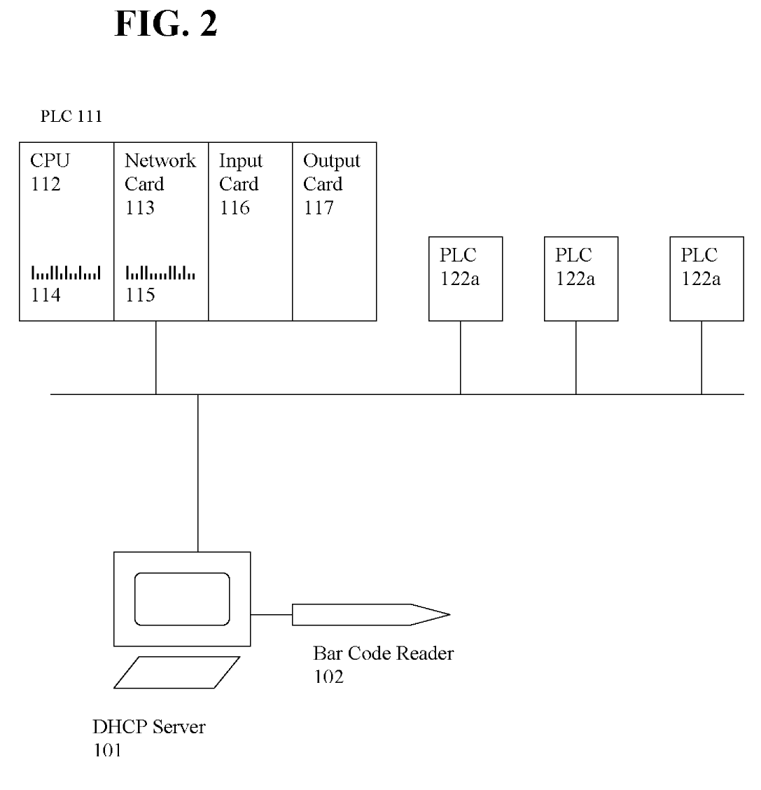

FIG. 2 shows a diagram of a factory automation network 121 with several programmable logic controllers (PLCs) 122a, 122b, 122c and 111 attached. There is also a DHCP server 101. The DHCP server 101 has a bar code reader 102 attached to it. DHCP server 101, typically, but not exclusively, is a personal computer connected to the network 121 running network management software designed to process DHCP requests. This software answers network requests to translate an IP address into a MAC address, and is essentially a database to map one address into the other. The software contains a user interface to allow a user to add, delete, or replace a MAC address in the database.

The PLC 111 is a detailed drawing of the various elements of one type of PLC. The PLC 111 contains a CPU card 112, an input card 116, an output card 117, and a network card 113. The PLC 111 also contains a bar code IP address 114 for that particular address. This address is optional, and used for adding a new device. While the bar code 114 is placed on the CPU 112 in this drawing, it can be placed anywhere in the PLC 111.

The network card 113 also contains a bar code address 115. However, the bar code 115 on the network card 113 contains the MAC address of the network card.

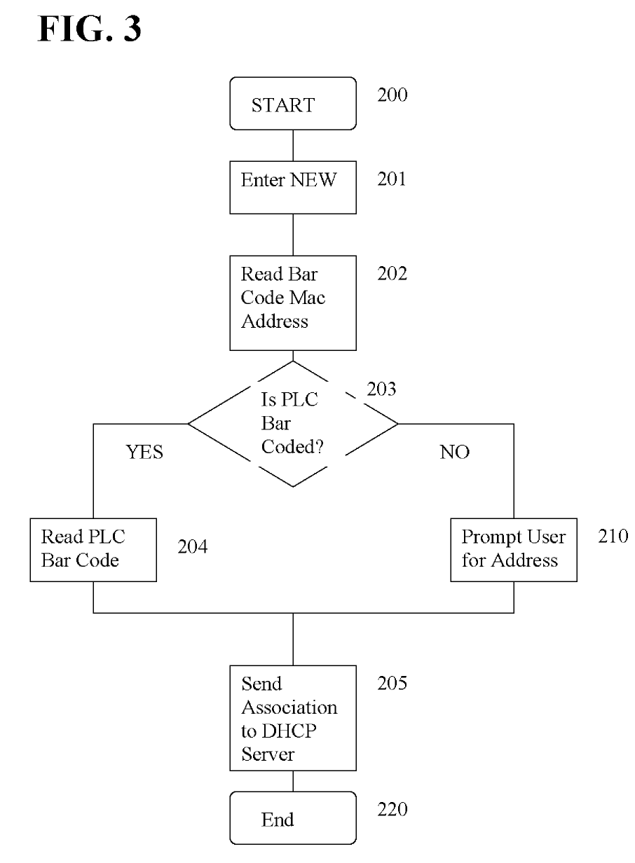

FIG. 3 contains a flow chart of the operation needed to add a new network device to the DHCP server. The procedure starts 200 when the user tells the software to enter a new MAC address 201. The user then uses the bar code reader 102 to read the MAC address 115 from the network card 113 in the next step 202. If the PLC 111 has a bar code 114 (step 203), then the user uses the bar code reader 102 to read the IP address bar code 114 from the PLC 111 in step 204. If there are no IP addresses on the PLC 111 to scan, then the user will have to enter the IP address manually in step 210. The software then associates the IP address 114 to the MAC address 115 in the DHCP database in step 205, and the process is complete 220.

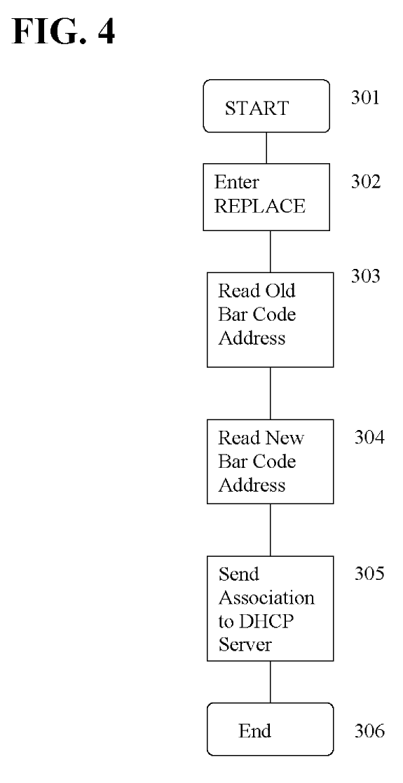

In FIG. 4, there is a flow chart that explains the operation needed to replace a network card or device. The process starts 301 with the user designating the desire to replace a network device in step 302. The user then scans the old MAC address bar code 115 with the bar code reader 102 in step 303. Next, the user scans the new bar code 115′ with the bar code reader 102 in step 304. In step 305 the software associated the IP address that was associated with MAC address 115 with the new MAC address 115′ through a simple lookup and replace algorithm, and the process is complete 306.

While the above description describes a specific embodiment of this invention, a number of other possibilities are envisioned, and the scope of protection is only limited by the scope of the accompanying claims.

1. A network device for industrial control comprising:
a network connection between said network device and an industrial control network;
a MAC address for said network device providing an address on the industrial control network,
wherein said MAC address is an unique address of said network device;
and
a representation of the MAC address in a bar code format visible on said network device.

2. The network device of claim [1]
wherein the bar code is read by a bar code reader that communicates said MAC address to a DHCP server.

3. The network device of claim [1]
wherein the bar code is read by a bar code reader that communicates said MAC address to a BOOTP server.

4. The network device of claim [1]
wherein the network device is a programmable logic controller.

5. The network device of claim [1] wherein the industrial control network is an Ethernet network.

6. The method of assigning a network address to a MAC address on an industrial control network comprising:
indicating the desire to replace a first network device with a second network device;
scanning a first bar code that contains a first MAC address of the first network device;
scanning a second bar code that contains a second MAC address of the second network device;
updating a network database, replacing said first MAC address with said second MAC address.

7. The method of assigning a network address to a MAC address of claim [6] wherein said network database is a table for a BOOTP server.

8. The method of assigning a network address to a MAC address of claim [6] wherein said network database is a table for a DHCP server.

9. The method of assigning a network address to a MAC address of claim [6] wherein the network address is an Internal Protocol (IP) address.

10. The method of assigning a network address to a MAC address of claim [6] further comprising the step of physically replacing the first device with the second device.

11. The method of assigning a network address to a MAC address on an industrial control network comprising:
indicating the desire to add a network device to a network database;
scanning a bar code that contains a MAC address of the network device;
identifying an Internet Protocol (IP) address;
updating a network database, adding said MAC address to the network database, said addition including both said MAC address and said Internet Protocol (IP) address.

12. The method of assigning a network address to a MAC address of claim [10] wherein the method of identifying said Internet Protocol (IP) address consists of scanning a bar code representation of said Internet Protocol (IP) address.

13. The method of assigning a network address to a MAC address of claim [10] wherein said network database is a table for a BOOTP server.

14. The method of assigning a network address to a MAC address of claim [10] wherein said network database is a table for a DHCP server.
